(19) United States
(12) Patent Application Publication
(10) Pub. No.: US 2020/0353686 A1
(43) Pub. Date: Nov. 12, 2020

(54) LIGHTING ASSEMBLY FOR ADDITIVE MANUFACTURING

(71) Applicant: HEWLETT-PACKARD DEVELOPMENT COMPANY, L.P., Spring, TX (US)

(72) Inventors: Alvin Post, Vancouver, WA (US); Brent C. Ewald, Vancouver, WA (US); Luke P. Sosnowski, Vancouver, WA (US)

(21) Appl. No.: 16/603,603

(22) PCT Filed: Jan. 31, 2018
(86) PCT No.: PCT/US2018/016073

§ 371 Date: Oct. 8, 2019

(51) Int. Cl. B29C 64/291; B33Y 30/00; B33Y 40/20; B29C 64/165

(52) U.S. Cl. CPC B29C 64/291; B33Y 30/00; B29K 2077/00; B29C 64/165; B33Y 40/20

(57) ABSTRACT

In one example, a fusing system for an additive manufacturing machine includes a stationary lighting assembly positioned over a work area and structured to simultaneously irradiate the entire work area with fusing light.

### BACKGROUND

Additive manufacturing machines produce 3D objects by building up layers of material. Some additive manufacturing machines are commonly referred to as “3D printers.” 3D printers and other additive manufacturing machines make it possible to convert a CAD (computer aided design) model or other digital representation of an object into the physical object. The model data may be processed into slices defining that part of a layer or layers of build material to be formed into the object.

### DRAWINGS

FIGS. 1 and 2 illustrate an example of a fusing system for an additive manufacturing machine.

FIGS. 3 and 4 illustrate an example of a lighting assembly for a fusing system such as the one shown in FIGS. 1 and 2.

FIGS. 5 and 6 illustrate another example of a lighting assembly for a fusing system such as the one shown in FIGS. 1 and 2.

FIG. 7 illustrates another example of a lighting assembly for a fusing system such as the one shown in FIGS. 1 and 2.

FIGS. 8-17 illustrate an example of a fusing system for an additive manufacturing machine.

The same part numbers designate the same or similar parts throughout the figures. The figures are not necessarily to scale.

### DESCRIPTION

In some additive manufacturing processes, light is used to help melt, bind, or otherwise fuse together the particles in a powdered build material. In one example of a thermal fusing process, heat to fuse the build material is generated by applying a light absorbing liquid fusing agent to a thin layer of powdered build material in a pattern based on the corresponding object slice, and then irradiating the patterned material with fusing light. Heat generated internally as light is absorbed by components in the fusing agent helps melt the build material. The process is repeated layer by layer and slice by slice to complete the object. In one example of a chemical fusing process, the liquid fusing agent is a chemical binder applied to the build material to chemically bind the powder together in the desired pattern, and then irradiating the patterned material with fusing light to dry and/or cure the binder agent. The process is repeated layer by layer and slice by slice to complete the object. After separating the object from the unfused build material, the object may undergo subsequent heat treatment to obtain the final structural characteristics for the object.

A stationary lighting assembly positioned over the work area in an additive manufacturing machine may be structured to simultaneously irradiate the entire work area uniformly with fusing light, and with less wasted light falling outside the work area compared to scanning light systems. In one example, the lighting assembly includes a light source and an optic to distribute light from the light source uniformly over the work area. “Uniform” in this context means the irradiance (radiant flux per unit area) does not vary by more than 20% between any two locations within the work area. Modeling indicates that distributing fusing light uniformly over the work area from a stationary source can reduce power consumption and cycle time compared to scanning light systems. For some additive manufacturing fusing processes, thermal melting for example, it may be desirable to utilize a higher degree of uniformity, below 3% for example, for more efficient fusing. For other additive manufacturing fusing processes, chemical binding for example, a lower degree of uniformity, up to 20% for example, may be adequate for efficient fusing. The light source may be implemented, for example, as a lamp (or group of lamps) to emit incoherent light or a laser or other source to emit a beam of light. The optic may be implemented, for example, as a reflective hood covering a group of lamps to direct the light uniformly over the work area or as a pair of Powell lenses to distribute a light beam uniformly over the work area.

These and other examples described below and shown in the figures illustrate but do not limit the scope of the patent, which is defined in the Claims following this Description.

As used in this document: “and/or” means one or more of the connected things; “light” means electromagnetic radiation of any wavelength; “stationary” means the stationary thing does not move with respect to a work area in operation during fusing; irradiating a work area “uniformly” means the irradiance (radiant flux per unit area) does not vary by more than 20% between any two locations within the work area; and “work area” means that part of the surface of any suitable structure to support or contain build material for fusing, including underlying layers of build material and in-process object structures, within which an object is manufactured.

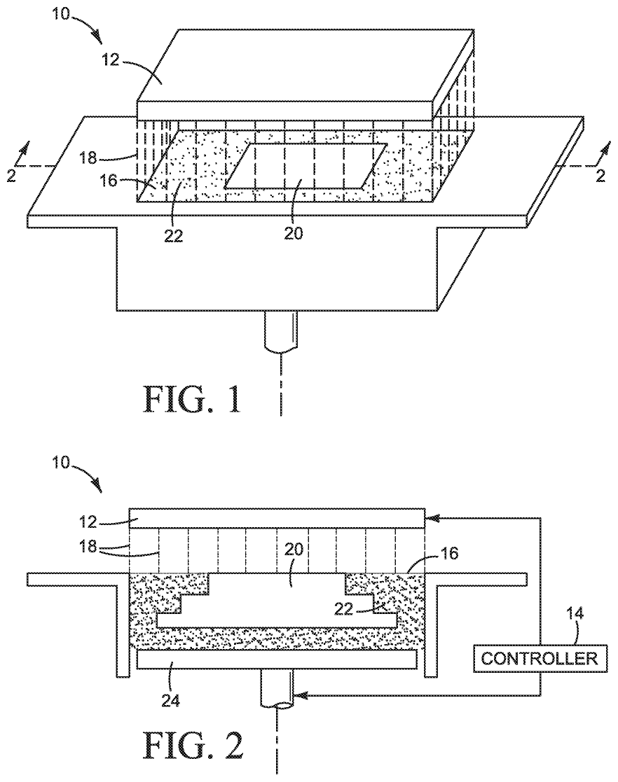

FIG. 1 illustrates one example of a fusing system 10 for an additive manufacturing machine. FIG. 2 is an elevation viewed along the line 2-2 in FIG. 1. Referring to FIGS. 1 and 2, fusing system 10 includes a stationary lighting assembly 12 and a controller 14. As noted above, “stationary” in this context means the lighting assembly does not move with respect to the work area in operation during fusing. The lighting assembly, however, does not have to be immovable. For example, the position of the lighting assembly, or components within the lighting assembly, may be calibrated or otherwise adjusted to maintain the desired lighting characteristics. Lighting assembly 12 and controller 14 are depicted generally by blocks 12, 14 in FIGS. 1 and 2.

Lighting assembly 12 is structured to simultaneously irradiate a work area 16 uniformly with fusing light 18 at the direction of controller 14. In the example shown in FIGS. 1 and 2, light assembly 12 is centered over work area 16. An object 20 is manufactured by fusing build material powder 22 in a succession of thin layers on a build platform 24 that is moved incrementally lower to accommodate each layer, at the direction of controller 14. Controller 16 represents the processing and memory resources and the programming, electronic circuitry and components needed to control the operative elements of system 10, including lighting assembly 12 and build platform 24.

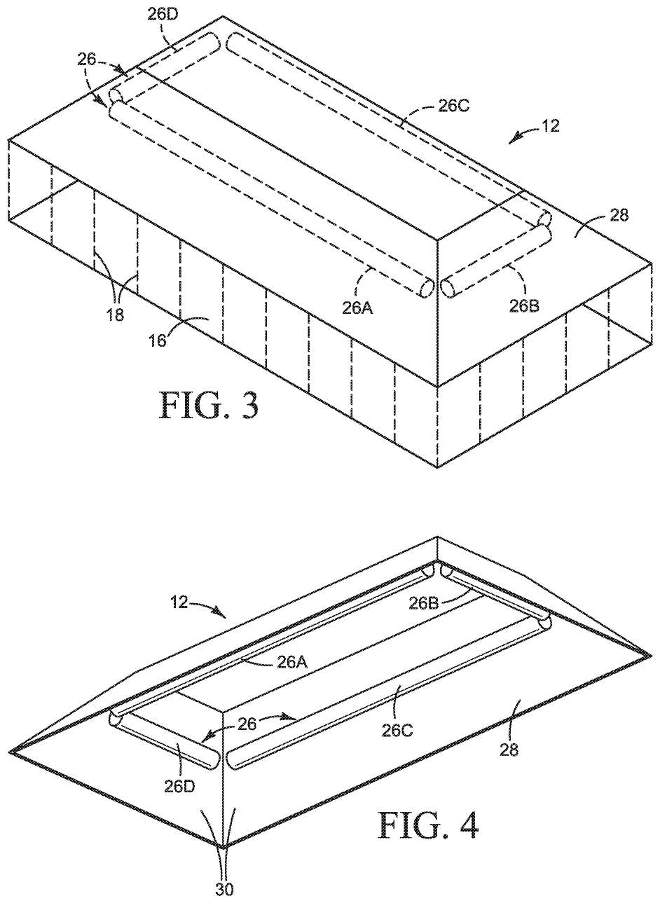

FIGS. 3 and 4 illustrate one example of a lighting assembly 12 for a fusing system 10 shown in FIGS. 1 and 2. Referring to FIGS. 3 and 4, lighting assembly 12 includes a light source 26 and an optic 28 to distribute light from light source 26 uniformly over work area 16 as fusing light 18. In this example, light source 26 is implemented as a group of lamps 26A, 26B, 26C, and 26D and optic 28 is implemented as a reflective hood 28 covering lamps 26A-26D. Also, in this example, cylindrical lamps 26A-26D are arranged along the perimeter 30 of a rectangular hood 28 shaped like a truncated pyramid. Some of the light from lamps 26A-26D is emitted directly on to work area 16 and some is reflected by hood 28 onto work area 16, as fusing light 18.

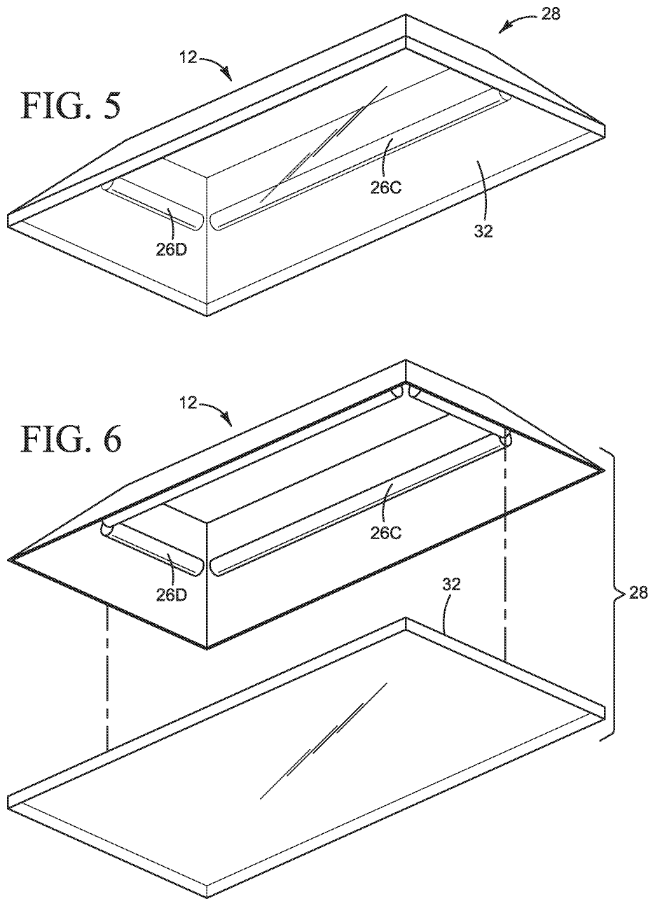

In another example, shown in FIGS. 5 and 6, lighting assembly 12 includes a transparent barrier 32 across the bottom of hood 28 to isolate the lamps from the surrounding environment while still allowing the distribution of fusing light 18.

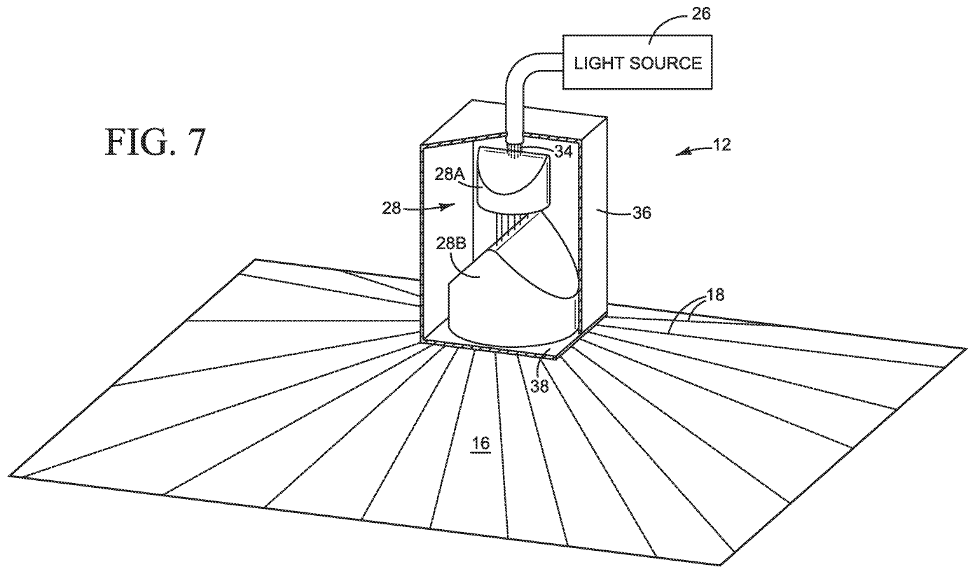

FIG. 7 illustrates another example of a lighting assembly 12 for a fusing system 10 shown in FIGS. 1 and 2. Referring to FIG. 7, lighting assembly 12 includes a light source 26 and an optic 28 to distribute light from light source 26 uniformly over work area 16, as fusing light 18. In this example, light source 26 is implemented as a laser or other source of a light beam 34 and optic 28 is implemented as a pair of Powell lenses 28A, 28B oriented perpendicular to one another. Lenses 28A, 28B distribute light beam 34 uniformly over a rectangular work area 16 as fusing light 18. In this example, lenses 28A, 28B are housed in an enclosure 36 with a transparent floor 38 to isolate the lenses from the surrounding environment while still allowing the distribution of fusing light 18. Other suitable configurations fora stationary lighting assembly 12 are possible.

The characteristics of the source 26 of fusing light 18 may vary depending on characteristics of the build material and fusing agent (and other fusing process parameters). For example, it is expected that a stationary lighting assembly 12 configured to emit a radiant flux energy of at least 5 J/cm² for fusing light 18 will be sufficient in many additive manufacturing applications that use a polyamide build material powder. In one specific example for a polyamide build material, a 2800 W (total) light source 26 with an optic 28 configured to provide about 16 J/cm² for energy consumption at the work area will deliver fusing light 18 comparable to that delivered by a 4300 W (total) scanning light source for similar manufacturing conditions. Also, a higher color temperature light source may be desirable to better match the spectral absorption of white or other light colored build material 22 treated with a black or other high absorption, low tint fusing agent, for more heating of the treated build material and less heating of the adjacent untreated build material. For example, a light source 26 operating in the range of 1500K to 3500K may be used to achieve the desired level of power absorption for effectively fusing a white build material 22 treated with a black fusing agent. In some additive manufacturing implementations using a lighting assembly 12 to generate fusing light 18, it may be desirable to also include warming lamps to help pre-heat the build material before applying a fusing agent.

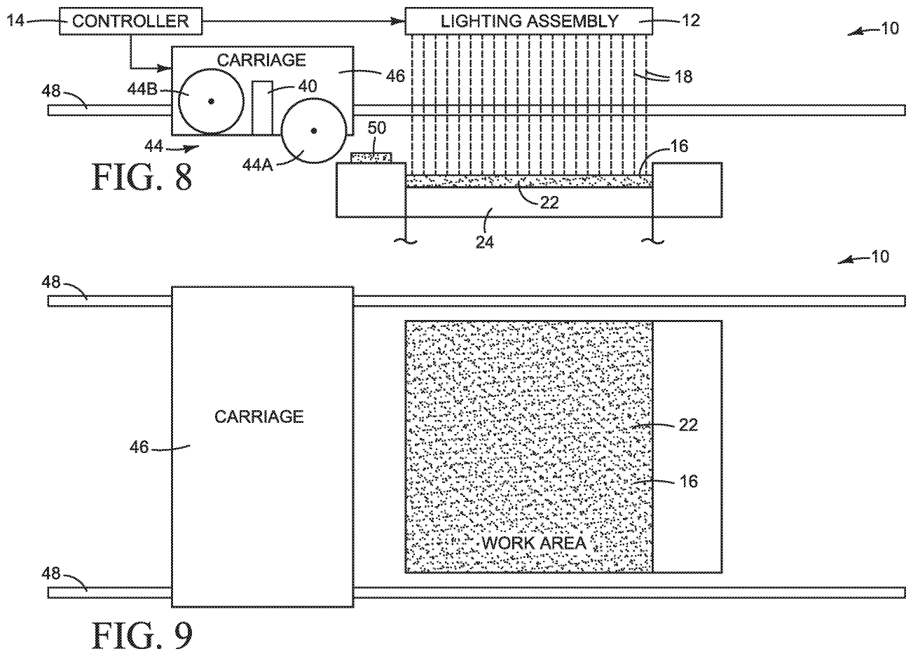

FIGS. 8-17 are elevation and plan views illustrating one example of a fusing system 10 for an additive manufacturing machine. Referring to FIGS. 8-17, fusing system 10 includes a stationary lighting assembly 12 over a work area 16, a liquid fusing agent dispenser 40 and a layering device 44 carried by a carriage 46, and a controller 14 (FIG. 8) to control the operative elements of fusing system 10. Lighting assembly 12 is omitted from the plan views to not obscure the underlying structures. Lighting assembly 12 is structured to simultaneously irradiate the whole of work area 16 uniformly with fusing light 18. Lighting assembly 12 may be implemented as a light source 26 and optic 28, for example as shown in FIGS. 3-7.

Carriage 46 carries layering device 44 and dispenser 40 over work area 16 on rails 48. Dispenser 40 may be implemented as an inkjet printhead or other suitable liquid dispensing device. Although a single dispenser is shown, more dispensers may be used to dispense a single agent or multiple agents. In the example shown in FIG. 8, layering device 44 is implemented as a pair of rollers 44A, 44B that each move between a deployed position to layer build material as carriage 46 moves over work area 16 and a retracted position to not layer build material as carriage 46 moves over work area 16. Other implementations for a layering device 44 are possible including, for example, a blade or a device that dispenses build material in a layer directly over the work area.

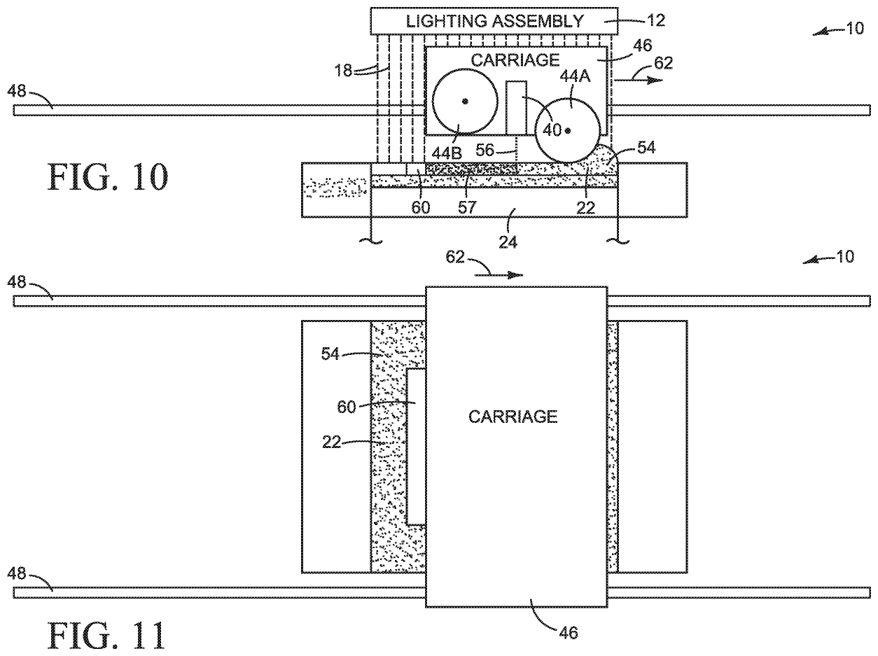

In FIGS. 8 and 9, carriage 46 is parked on the left side of work area 16 with roller 44A deployed with a supply 50 of build material powder 22 next to work area 16 in preparation for the next layer. In FIGS. 10 and 11, work area 16 is irradiated with fusing light 18 as carriage 46 moves to the right, indicated by motion arrows 62, with layering roller 44A deployed to form a next layer 54 of build material 22. Also as carriage moves left to right over work area 16, a fusing agent 56 is dispensed from dispenser 40 on to layer 54 in a pattern 57 corresponding to an object slice. Patterned build material 57 irradiated with fusing light 18 behind carriage 46 fuses to form fused build material 60.

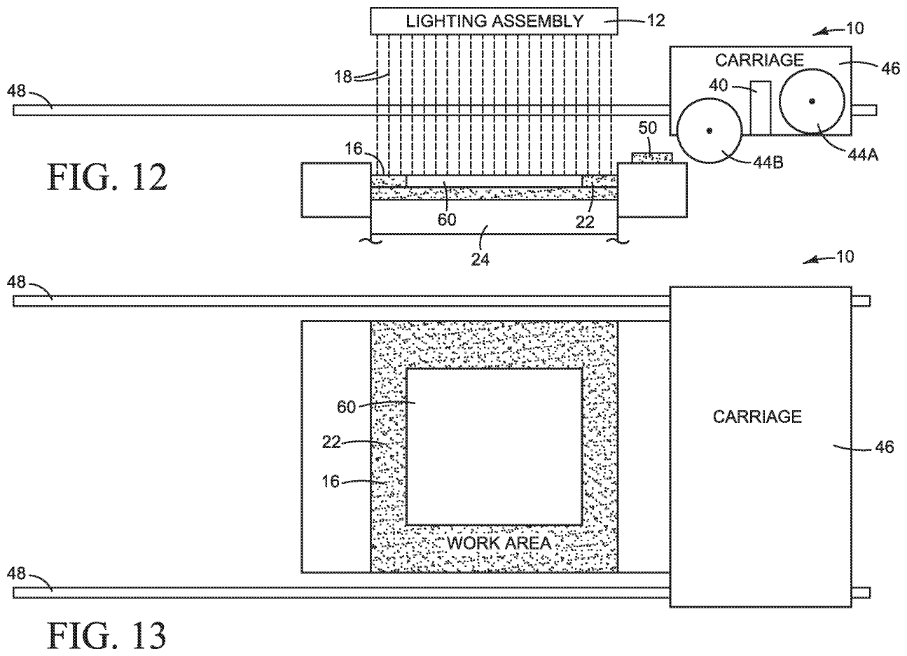

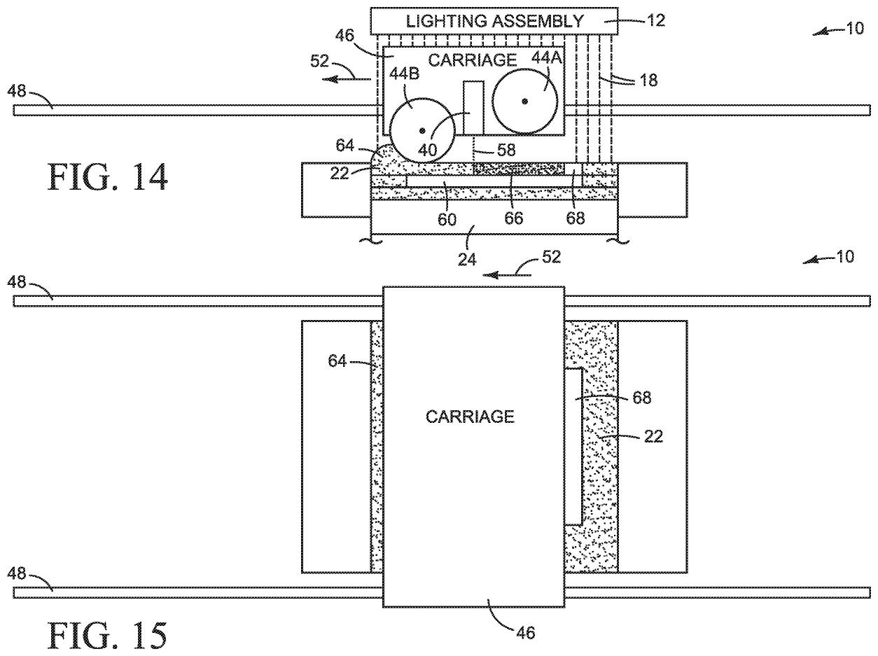

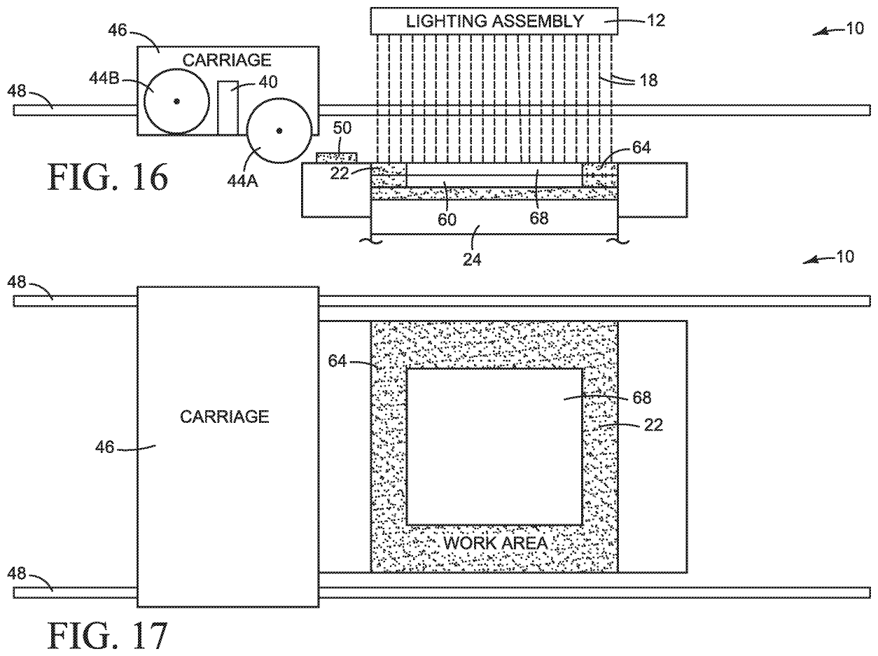

In FIGS. 12 and 13, carriage 46 has reached the right side of work area 16, fusing light 18 continues to irradiate the now fully exposed layer 54, roller 46B is deployed and a supply 50 of build material powder 22 is deposited next to work area 16 in preparation for the next layer. Carriage 46 may remain parked with fusing light 18 on to allow adequate time to achieve the desired reptation of fused build material 60. Fusing light 18 may be turned off, if desired, to allow fused build material 60 to cool before spreading the next layer of build material. In FIGS. 14 and 15, carriage 46 is moving to the left, back over work area 16 as indicated by direction arrows 52, with roller 44B deployed forming the next layer 64, pattern 66 and fused build material 68. In FIGS. 16 and 17, carriage 46 has reached the left side of work area 16 and fusing light 18 continues to irradiate the now fully exposed layer 64. Carriage 46 may remain parked with fusing light 18 on to allow adequate time to achieve the desired reptation of fused build material 68. Fusing light 18 may be turned off, if desired, to allow fused build material 68 to cool before spreading the next layer of build material. Manufacturing continues layer by layer until the object is completed.

The examples shown in the figures and described above illustrate but do not limit the patent, which is defined in the following Claims.

“A”, “an” and “the” used in the claims means at least one. For example, “a fusing lamp” means one or more fusing lamps and subsequent reference to “the fusing lamp” means the one or more fusing lamps.

1. A fusing system for an additive manufacturing machine, comprising a stationary lighting assembly positioned over a work area and structured to simultaneously irradiate the entire work area uniformly with fusing light.

2. The system of claim 1, where the lighting assembly includes a light source and an optic to distribute light from the light source uniformly over the work area.

3. The system of claim 2, where the light source includes a light source to emit a beam of light and the optic includes a lens to distribute a beam of light from the light source uniformly over the work area.

4. The system of claim 3, where the light source includes a laser and the lens includes a pair of Powell lenses oriented orthogonal to one another to distribute a laser beam from the laser uniformly over the work area.

5. The system of claim 2, where the light source includes a lamp and the optic includes a reflector to reflect light from the lamp uniformly over the work area.

6. The system of claim 5, where the lamp includes multiple lamps and the reflector includes a rectangular reflective hood covering the lamps.

7. The system of claim 1, where the lighting assembly is configured to emit a radiant flux energy of at least 5 J/cm² to the work area.

8. The system of claim 7, where the fusing light has a color temperature of 1500K to 3500K.

9. A fusing system for an additive manufacturing machine, comprising:
a movable platform to support a work area, the platform movable incrementally lower to accommodate a succession of layers of powdered build material;
a carriage movable over the platform;
a dispenser carried by the carriage to selectively dispense a liquid fusing agent on to a work area supported on the platform as the carriage moves over the platform; and
a stationary lighting assembly positioned over the platform and structured to simultaneously irradiate the entirety of a work area supported on the platform with a fusing light except where the fusing light is blocked by the carriage moving over the work area.

10. The system of claim 9, where the lighting assembly is structured to simultaneously irradiate the entirety of the work area uniformly with fusing light except where the fusing light is blocked by the carriage moving over the work area.

11. The system of claim 9, where the lighting assembly includes a light source to emit a beam of light and a lens to distribute a beam of light from the light source over the work area.

12. The system of claim 9, where the lighting assembly includes a lamp and a reflector to reflect light from the lamp over the work area.

13. A lighting assembly for an additive manufacturing machine, comprising:
a stationary light source to emit light with a color temperature of 1500K to 3500K and a radiant flux energy of at least 5 J/cm²; and
a stationary optic to distribute light from the light source uniformly over a work area when the lighting assembly is installed and operating in the additive manufacturing machine.

14. The assembly of claim 13, where:
the light source includes multiple quartz-halogen lamps each to emit light with a color temperature of 1500K to 3500K; and
the optic includes a reflective hood covering the lamps.

15. The assembly of claim 14, where the reflective hood is rectangular and the lamps are arranged around a perimeter of the hood.
